(19) United States
(12) Patent Application Publication
(10) Pub. No.: US 2023/0101264 A1
(43) Pub. Date: Mar. 30, 2023

(54) ISSUE TRACKING SYSTEM WITH ASSOCIATED ISSUES FUNCTIONS

(71) Applicants: Atlassian Pty Ltd., Sydney (AU); Atlassian Inc., San Francisco, CA (US)

(72) Inventors: Vasanthi Baskar, Sydney (AU); Gabriel David Tonin Raubenheimer, Sydney (AU); Oliver Wessels, Sydney (AU); Alexander Spence, Sydney (AU); Vincent Chi-Kit Wong, Sydney (AU); Amy Yu, Sydney (AU); Jose Ignacio Romagnoli, Sydney (AU)

(21) Appl. No.: 17/489,114

(22) Filed: Sep. 29, 2021

(51) Int. Cl. G06Q 10/00; G06Q 10/10; G06F 11/36

(52) U.S. Cl. CPC G06Q 10/20; G06Q 10/1093; G06F 11/3604; G06Q 10/103

(57) ABSTRACT

Described herein are computer implemented methods and apparatus for providing an issue tracking system. The issues of the issue tracking system are associable with objects. The issues are in categories or are of types. Depending on at least one of the associations with objects and the categorisation or type, the issue tracking system provides the user with indicia representing the association of issues with a common object.

### FIELD

Aspects of the present disclosure are directed to issue tracking systems, for example, a project management system, and in particular to issue tracking systems with data structures and data processing to provide functions for processing associated issues.

### BACKGROUND

Product and service development and maintenance is often a key function within an organisation. Issue tracking systems have been developed to assist with this function. The issue tracking system provides an accessible record of one or more tasks to be performed to deliver a product or service. For example, where the product is a software application or the service is software as a service, the issue tracking system maintains issues relating to the product or service, including issues defining or relating to a development or maintenance task.

The issue tracking system may provide a range of functions including, for example, one or more of functions to identify the workflow of and track the progress of a plurality of issues, functions to allocate people and other resources to issues and functions to allocate issues to projects. Issue tracking systems may handle a large number of issues for a variety of projects and services. In a large issue tracking system, it may be difficult to identify and manage relationships between issues and objects handled by the system.

Background information described in this specification is background information known to the inventors. Reference to this information as background information is not an acknowledgment or suggestion that this background information is prior art or is common general knowledge to a person of ordinary skill in the art.

### SUMMARY

Example embodiments described herein are directed to a computer implemented method for providing an issue tracking system. The issue tracking system includes a first issue of a first category or type and a second issue of a second category or type. The first issue is designated by the issue tracking system as associated with a first object of the issue tracking system and the second issue is designated by the issue tracking system as associated with the first object of the issue tracking system. The method includes determining that a) the first issue is of the first category or type and not the second category or type; b) the first issue is associated with the first object; and c) the first object is associated with the second issue. The first issue is displayed based on these determinations.

Example embodiments described herein also relate to a computer implemented method that includes receiving at a computer processing system a request to create a first issue and a second issue for an issue tracking system, a designation of an issue category or type for the issues and a designation of at least one object for the issues. The method includes creating the first issue and the second issue for the issue tracking system, including storing in data storage data defining the first issue and the second issue, including data representing the received designations. While displaying details of the first issue in a user interface of the issue tracking system, the method includes displaying indicia that indicates that the second issue includes a designation of the first service or the first product.

Example embodiments described herein also relate to a computer processing system including a processing unit, a communication interface and a non-transitory computer-readable storage medium storing instruction, which when executed by the processing unit, cause the processing unit to provide an issue tracking system. Providing the issue tracking system includes: providing in data storage an object registry for defining objects to which issues relate, wherein the objects relate to a product or service; providing in data storage an issue store for a plurality of issues; and causing, through the communications interface, a user interface to be displayed on a display device, the user interface including a plurality of screen displays navigable by a user of the issue tracking system. The plurality of screen displays include: at least one screen display for creating or editing an issue for or in the issue store, including a first screen display for selecting an object from the object registry for association with the issue; at least one screen display for presenting details of an issue, including a second screen display that displays details of a first issue associated with an object from the object registry and includes indicia that indicates there is at least a second issue in the issue store associated with the same object in the object registry.

Example embodiments described herein also relate to a non-transitory storage medium storing instructions executable by processing unit to cause the processing unit to perform functions described herein. For example the instructions may cause the processing unit to provide an issue tracking system, the provision including: providing in data storage an object registry for defining objects to which issues relate, wherein the objects relate to a product or service; providing in data storage an issue store for a plurality of issues; and causing, through the communications interface, a user interface to be displayed on a display device, the user interface including a plurality of screen displays navigable by a user of the issue tracking system. The plurality of screen displays include: at least one screen display for creating or editing an issue for or in the issue store, including a first screen display for selecting an object from the object registry for association with the issue; at least one screen display for presenting details of an issue, including a second screen display that displays details of a first issue associated with an object from the object registry and includes indicia that indicates there is at least a second issue in the issue store associated with the same object in the object registry.

### BRIEF DESCRIPTION OF THE DRAWINGS

FIG. 1 is a diagram depicting a networked environment in which various features of the present disclosure may be implemented.

FIG. 2 is a block diagram of a computer processing system configurable to perform various features of the present disclosure.

FIG. 3 shows a functional representation of aspects of an issue tracking system.

FIG. 4 shows a flow diagram of a process performed by an issue tracking system.

FIG. 5 shows a flow diagram of another process performed by an issue tracking system.

FIG. 6 shows an example screen display of an issue tracking system.

FIG. 7A shows an example screen display of an issue tracking system.

FIG. 7B shows an example screen display of an issue tracking system.

FIG. 8 shows an example screen display of an issue tracking system.

FIG. 9 shows an example screen display of an issue tracking system.

### DETAILED DESCRIPTION

In the following description numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

Generally, an issue tracking system may be part of a project management application providing a range of functions, including for example one or more of functions to identify the workflow of and track the progress of a plurality of issues, functions to allocate people and other resources to issues and functions to allocate issues to projects. An example of a product or service development activity may be called a “change request.” An example of a product or service maintenance activity may be called an “incident” or a “ticket.”

The following description is made with specific reference to the example of functionality added to or which interacts with an issue tracking system in the form of a project management system. The project management system may include a project management application providing a range of functions, including for example one or more of functions to identify the workflow of and track the progress of a plurality of issues, functions to allocate people and other resources to issues, functions to allocate issues to projects, and functions to identify a roadmap for a product based on the projects and/or issues relating to the product. An example of a project management system for project management teams is the family of products generally called Jira Software™, available from Atlassian, Inc or Atlassian Pty Ltd. It will be appreciated that the issue tracking functionality described herein may be implemented with or without the additional functionality provided by a project management system.

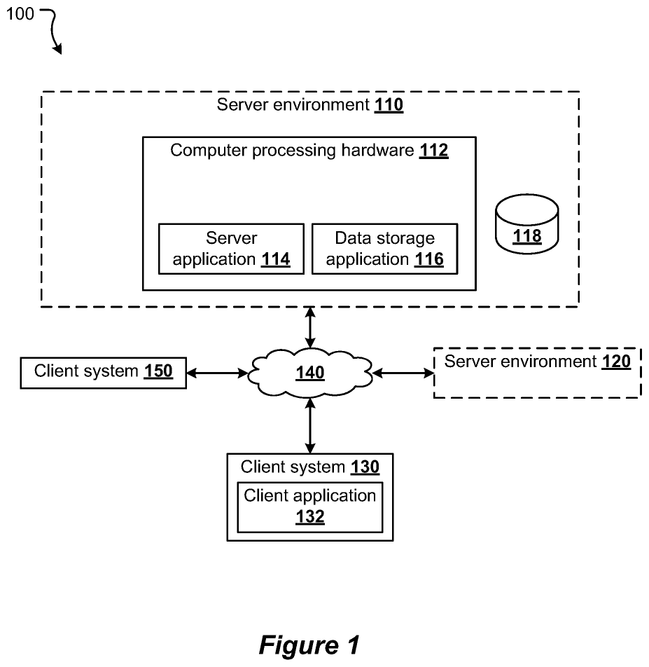

FIG. 1 depicts one example of a networked environment 100 in which the operations and techniques described herein can be performed. Networked environment 100 includes a server environment 110 and a client system 130 which communicate via one or more communications networks 140 (e.g., the Internet).

Generally speaking, the server environment 110 includes computer processing hardware 112 (discussed below) on which applications that provide server-side functionality to client applications such as client application 132 (described below) execute. In the present example, server environment 110 includes a server application 114, which may also be referred to as a front-end server application, and a data storage application 116.

The server application 114 executes to provide a client application endpoint that is accessible over the communications network 140. To do so, the server application 114 may include one or more application programs, libraries, APIs or other software elements that implement the features and functions that are described herein. For example, where server application 114 serves web browser client applications the server application 114 will be a web server, which receives and responds to, for example, HTTP application protocol requests. Where server application 114 serves native client applications, server application 114 will be an application server configured to receive, process, and respond to API calls from those client applications

The server environment 110 may include both web server and application server applications allowing it to interact with both web and native client applications.

Server application 114 (and/or other applications running in the server environment 110) can be implemented as a monolithic application. Alternatively, server application 114 can be implemented as a collection of independent and autonomous application services (e.g., micro-services). In this case, the constituent application services of server application 114 communicate amongst themselves, with other front end server applications 114, and/or with client applications 132, via defined interfaces such as web APIs.

. The server application 114 provides issue tracking functionality, including the functionality described herein and may implement a project management system, for example Jira Software™. In addition to the specific functionality described herein, the server application 114 (alone or in conjunction with other applications) may provide additional functions that are typically provided by server systems—for example, user account creation and management, user authentication, and/or other server-side functions.

The data storage application 116 provides functionality to receive and process requests to persistently store and retrieve data that is relevant to the operations performed/services provided by the server environment 110. Such requests may be received from the server application 114, other server environment applications, and/or (in some instances) directly from client applications such as the client application 132. Data relevant to the operations performed/services provided by the server environment includes data defining issues for the issue tracking system.

The data storage application 116 may, for example, be a relational database management application or an alternative application for storing and retrieving data from data storage 118. Data storage application 116 stores data to and retrieves data from one or more non transient (or persistent) data storage 118—e.g., non-transient computer readable storage devices such as hard disks, solid state drives, tape drives, or alternative computer readable storage devices.

In server environment 110, server application 114 persistently stores data to data storage 118 via the data storage application 116. In alternative implementations, however, the server application 114 may be configured to directly interact with data storage 118 to store and retrieve data (in which case a separate data storage application may not be needed). Furthermore, while a single data storage application 116 is described, server environment 110 may include multiple data storage applications. In this case, each data storage application may interface with one or more shared data storage 118 and/or one or more dedicated data storage 118, and each data storage application may receive/respond to requests from various server-side and/or client-side applications (including, for example, the server application 114).

As noted, the server application 114 and data storage application 116 run on (or are executed by) computer processing hardware 112. Computer processing hardware 112 includes one or more computer processing systems. The precise number and nature of those systems will depend on the architecture of the server environment 110.

For example, in one implementation a single server application 114 runs on its own computer processing system and a single data storage application 116 runs on a separate computer processing system. In another implementation, a single server application 114 and a single data storage application 116 run on a common computer processing system. In yet another implementation, server environment 110 may include multiple server applications running in parallel (on one or multiple computer processing systems).

In a further implementation, server environment 110 is a scalable environment in which application instances (and the computer processing hardware 112—e.g., the specific computer processing systems required to run those instances) are commissioned and decommissioned according to demand—e.g., in a public or private cloud-type system. In this case, server environment 110 may simultaneously run multiple server applications 114 and/or multiple data storage applications 116 (on one or multiple computer processing systems) as required by client demand. Where server environment 110 is a scalable system it will include additional applications to those illustrated and described. As one example, the server environment 110 may include a load balancing application which operates to determine demand, direct client traffic to the appropriate server application instance 114 (where multiple server applications 114 have been commissioned), trigger the commissioning of additional server environment applications (and/or computer processing systems to run those applications) if required to meet the current demand, and/or trigger the decommissioning of server environment applications (and computer processing systems) if they are not functioning correctly and/or are not required for current demand.

As a further example, where an application (e.g., server application 114) is implemented as a collection of application services, each application service may run on its own computer processing system or multiple application services may run on a common computer processing system.

Communication between the applications (and/or application services) and computer processing systems of the server environment 110 may be by any appropriate means, for example, direct communication or networked communication over one or more local area networks, wide area networks, and/or public networks (with a secure logical overlay, such as a VPN, if required).

The present disclosure describes various operations that are performed by one or more applications of the server environment 110. However, operations described as being performed by a particular application (e.g., server application 114) could be performed by one or more alternative applications, and/or operations described as being performed by multiple separate applications could, in some instances, be performed by a single application.

The client system 130 hosts a client application 132, which, when executed by the client system 130, configures the client system 130 to provide client-side functionality and/or interact with server environment 110 (or, more specifically, the server application 114 and/or other application(s) provided by the server environment 110).

The client application 132 may be a general web browser application, which accesses the server application 114 via an appropriate uniform resource locator (URL) and communicates with the server application 114 via general world-wide-web protocols (e.g., http, https, ftp). Alternatively, the client application 132 may be a native application programmed to communicate with server application 114 using defined application programming interface (API) calls.

The client system 130 may have more than one client application 132 installed and executing thereon. For example, the client system 130 may have a (or multiple) general web browser application(s) and a native client application.

While networked environment 100 depicts a single client system 130, the server environment 110 will typically serve many client systems. The one or more additional client systems may be a client system 150, as shown in FIG. 1. Similarly, the networked environment 100 may include one or more additional server environments, which are represented in FIG. 1 by server environment 120.

The techniques and operations described herein are performed by one or more computer processing systems.

By way of example, client system 130 may be any computer processing system, which is configured (or configurable) by hardware and/or software to offer client-side functionality. A client system 130 may be a desktop computer, laptop computer, tablet computing device, mobile/smart phone, or other appropriate computer processing system.

Similarly, the applications of server environment 110 are also executed by one or more computer processing systems. Server environment computer processing systems will typically be server systems, though again may be any appropriate computer processing systems.

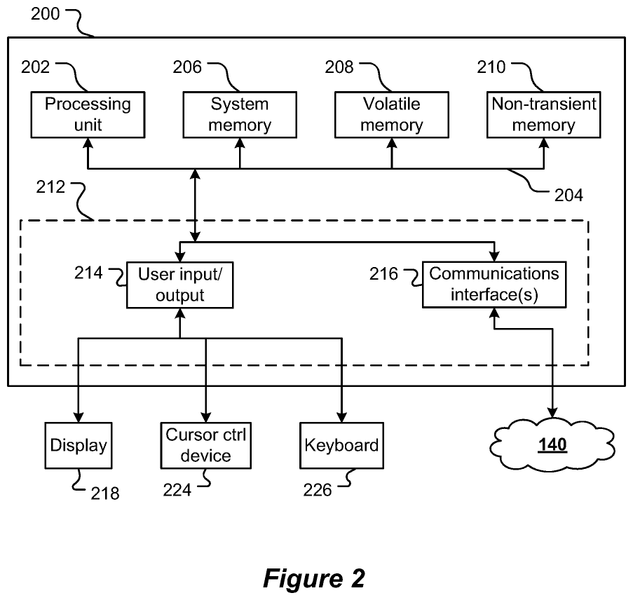

FIG. 2 provides a block diagram of a computer processing system 200 configurable to implement embodiments and/or features described herein. System 200 is a general-purpose computer processing system. It will be appreciated that FIG. 2 does not illustrate all functional or physical components of a computer processing system. For example, no power supply or power supply interface has been depicted, however system 200 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

Computer processing system 200 includes at least one processing unit 202. The processing unit 202 may be a single computer processing device (e.g., a central processing unit, graphics processing unit, or other computational device), or may include a plurality of computer processing devices. In some instances, where a computer processing system 200 is described as performing an operation or function, all processing required to perform that operation or function will be performed by the processing unit 202. In other instances, processing required to perform that operation or function may also be performed by remote processing devices accessible to and useable by (either in a shared or dedicated manner) the processing system 200.

Through a communications bus 204 the processing unit 202 is in data communication with one or more machine readable storage (memory) devices, which store computer readable instructions and/or data which are executed by the processing unit 202 to control operation of the processing system 200. In this example, processing system 200 includes a system memory 206 (e.g., a BIOS), volatile memory 208 (e.g., random access memory such as one or more DRAM modules), and non-transient memory 210 (e.g., one or more hard disks or solid-state drives).

The processing system 200 also includes one or more interfaces, indicated generally by 212, via which the processing system 200 interfaces with various devices and/or networks. Other devices may be integral with the processing system 200 or may be separate. Where a device is separate from the processing system 200, connection between the device and system 200 may be via wired or wireless hardware and communication protocols and may be a direct or an indirect (e.g., networked) connection.

Wired connection with other devices/networks may be by any appropriate standard or proprietary hardware and connectivity protocols. For example, the processing system 200 may be configured for wired connection with other devices/communications networks by one or more of: USB; eSATA; Ethernet; HDMI; and/or other wired connections.

Wireless connection with other devices/networks may similarly be by any appropriate standard or proprietary hardware and communications protocols. For example, the processing system 200 may be configured for wireless connection with other devices/communications networks using one or more of: Bluetooth; Wi-Fi; near field communications (NFC); Global System for Mobile Communications (GSM), and/or other wireless connections.

Generally speaking, and depending on the particular system in question, for example, whether the processing system 200 is part of the computer processing hardware 112 or part of the client system 130, devices to which the processing system 200 connects, whether by wired or wireless means, include one or more input devices to allow data to be input into/received by the processing system 200 and one or more output device to allow data to be output by system 200. Example devices are described below; however, it will be appreciated that not all computer processing systems will include all mentioned devices, and that additional and alternative devices to those mentioned may well be used.

For example, the processing system 200 may include or connect to one or more input devices by which information/data is input into (received by) the processing system 200. Such input devices may include keyboard, mouse, trackpad, microphone, accelerometer, proximity sensor, GPS, and/or other input devices. The processing system 200 may also include or connect to one or more output devices controlled by the processing system 200 to output information. Such output devices may include devices such as a display (e.g., a LCD, LED, touch screen, or other display device), speaker, vibration module, LEDs/other lights, and/or other output devices. The processing system 200 may also include or connect to devices which may act as both input and output devices, for example memory devices (hard drives, solid state drives, disk drives, and/or other memory devices) which the processing system 200 can read data from and/or write data to, and touch screen displays which can both display (output) data and receive touch signals (input).

By way of example, where the processing system 200 is a client system, such as the client system 130, it may include a display 218 (which may be a touch screen display), a cursor control device 224 (e.g., a mouse, trackpad, or other cursor control device) and a keyboard 226.

The processing system 200 also includes one or more communications interfaces 216 for communication with a network, such as network 140 of environment 100 (and/or a local network within the server environment 110). Via the communications interface(s) 216, system 200 can communicate data to and receive data from networked systems and/or devices.

The processing system 200 may be any suitable computer processing system, for example, a server computer system, a desktop computer, a laptop computer, a netbook computer, a tablet computing device, a mobile/smart phone, a personal digital assistant, or an alternative computer processing system.

The processing system 200 stores or has access to computer applications (also referred to as software or programs), e.g., computer readable instructions and data, which, when executed by the processing unit 202, configure the processing system 200 to receive, process, and output data. Instructions and data can be stored on non-transient machine memory 210 accessible to system 200. Instructions and data may be transmitted to/received by the processing system 200 via a data signal in a transmission channel enabled, for example, by a wired or wireless network connection the communications interface 216.

Typically, one application accessible to the processing system 200 will be an operating system application. In addition, the processing system 200 will store or have access to applications, which, when executed by the processing unit 202, configure the processing system 200 to perform various computer-implemented processing operations described herein. For example, and referring to the networked environment of FIG. 1 above, the server environment 110 includes one or more systems which run a server application 114, a data storage application 116. Similarly, client system 130 runs a client application 132.

In some cases, part or all of a given computer-implemented method will be performed by the processing system 200 itself, while in other cases, processing may be performed by other devices in data communication with processing system 200.

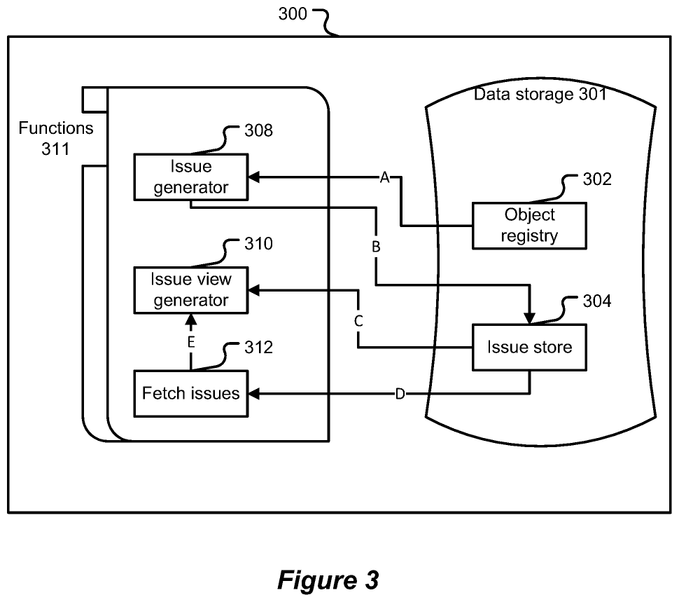

FIG. 3 shows a block diagram representation of selected functions 311 provided by one or more processing systems, which may be for example in the form of the processing system 200. The block diagram also shows selected data in data storage 301. The functions may be provided by and the data maintained by a project management system 300, which includes or consists of an issue tracking system. The project management system 300 may be provided in the networked environment 100. For example, the functions 311 may be provided by either one of, or both of, the server application 114 (optionally with the data storage application 116) and the client application 132 and the data storage 301 may be the data storage 118. In some embodiments the data storage 301 from which data is received and to which data is saved when performing the functions 311 may be or include local storage of a client device, for example volatile memory 208 and/or non-transient memory 210. Examples of embodiments with local storage include the network environment 100 (or other networked environment) utilising a local cache at a client device and embodiments in which the issue tracking system is implemented on a standalone computer device.

The data storage 301 includes an object registry 302. The object registry 302 stores predefined services or products (herein “objects”) that may be the subject of issues and incidents. An example service is one or more applications or functionality of applications that provide software as a service (“SaaS”). An example product may be an item or collection of hardware, for example, one or more computer servers or one or more personal computers. While both examples relate to issue tracking systems in the field of software and/or computer hardware, other objects may be defined in the object registry. The issue tracking system or project management system may include functionality to add, remove and edit objects from the object registry 302. For example, the functionality may include the server environment 110 and client system 130 providing a user interface at the client system 130 for managing the object registry 302.

The data storage 301 also includes an issue store 304. The issue store 304 stores data defining the issues maintained by the issue tracking service. An issue, as this term is used herein, is data that directly or indirectly defines a task to be performed. The data defining the task may be in a predefined data structure with various fields for containing content. For example, in the context of a project management system, a project may be viewed as a collection of one or more tasks. An example task is to address an identified bug within software. Another example task is to add an identified feature to software, for example by developing and testing code implementing the feature. Both example tasks may form part of the same project (or they may be part of different projects).

The issue tracking system includes a plurality of issue types. An issue type is a categorisation of an issue. For example, issues relating to addressing an identified bug within software may have a type called a “bug issue type,” whereas issues relating to adding a feature to software may have a different issue type, for example called a “feature issue type.” An issue type is stored associated with an issue to identify the categorisation of the issue. For example, the issue type may be defined by the content of a field in the data structure that defines the issue.

The issue tracking system includes at least two different categories of issue, including a first category of issue and a second category of issue. For clarity of explanation and by way of example, the first category of issue is called herein an “incident” and the second category of issue is called herein a “change request.” The first and second categories of issue are processed according to the embodiments described below. It will be appreciated that the name of these categories may be set by the developer of the issue tracking system and need not be “incident” and “change request.” Also, the allocation of and division between what tasks represent an incident and what tasks represent a change request may also be set by the developer of the issue tracking system. Examples of possible divisions are provided below, but these are not intended to be limiting.

For example, in some embodiments, the issue types include one or more types that are deemed by the issue tracking system to be incidents and therefore processed according to the embodiments described below. For example, the “bug issue type” may be an incident for the issue tracking system. In some embodiments, the issue types include one or more types that deemed by the issue tracking system to be change requests and therefore processed according to the embodiments described below. For example, the “feature issue type” may be a “change request” for the issue tracking system. It will be appreciated that where there is only one issue type that is deemed to be an “incident” or a “change request,” then the issue type and the category of issue merge.

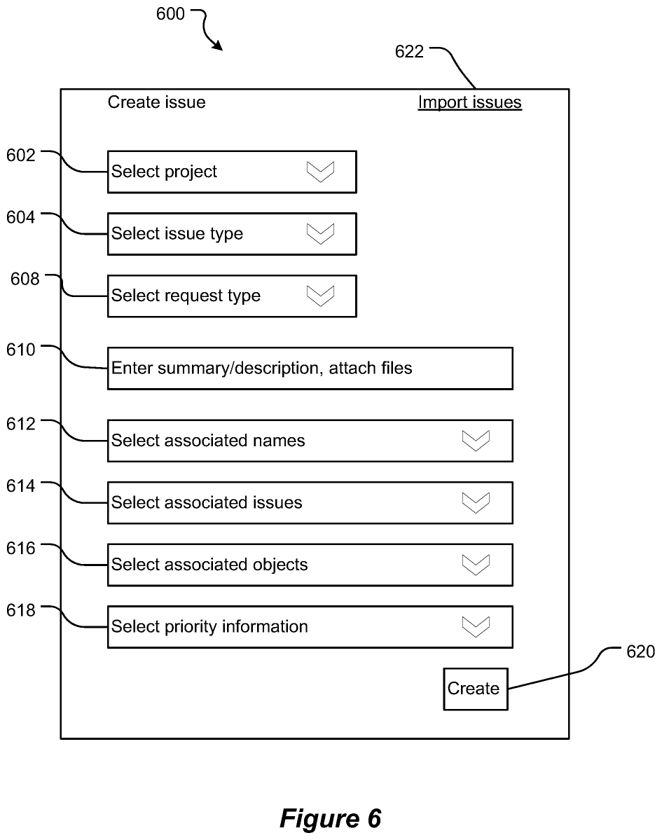

In other embodiments, a single issue has more than one issue type. For example, an issue may be set to be the “bug issue type” and may be set to be either a “change request” or an “incident.” To provide clarity to users, these issue types may be given different names. For example, a first set of issue types may be called “issue types” and the other set of issues may be called “request types” (FIG. 6 is an example screen display showing this arrangement). Either may be used to designate the issue as an “incident” or “change request” (or other category) and the other used to designate other categorisations and the other categorisations may control project management functionality, such as designating what workflow or workflows are associated with the issue. In this way, functionality to identify issues associated through a common object as described herein may be implemented independently or substantially independently of another project management functionality.

In other embodiments, data that is deemed to define a task relating to an incident is in one store in the data storage 301 and data that is deemed to define a task relating to a change request are in another store in the data storage 301. These two stores may be physically and/or logically separate and it is the location of the stores that directly or indirectly categorises the task. These other embodiments may be appropriate, for example, when the fields defining an incident are substantially different from the fields defining a change request.

In some use cases, an incident is a task relating to the operation of an existing service or product. For example, it might include a request for a fix of the service or to maintenance or repair of a product. In contrast a change request is relating to the future functionality of the service (e.g., the addition of a function or feature of the service) or future state of the product (e.g., an upgrade or replacement of part or all of the product).

In some use cases, an incident is a task that is sourced from existing users or use of the service or product. For example, a collection of one or more SaaS applications may include incident management functionality, or may be associated with an incident management system, to monitor the operation of a SaaS application, receive tickets for user requests for support and/or receive user interactions via a chat tool or the logs of calls to a service desk. The activities of the incident management functionality or system may serve as the basis for creating issues in the task tracking system that are deemed to be incidents.

The creation of an issue that is an incident may be a manual process, for example, by a user entering relevant information to create the task, with the information based on an output from the incident management functionality or system or may be an automated or semi-automated process. In an example of an automated process, the incident management functionality or system may be implemented by the server environment 120, which may communicate content defining an issue to the server environment 110, which receives the content for the creation of an issue in the task management service. In a semi-automated process, there is user control over the creation, the user control received at one or both of the server environment 110 and server environment 120. An example of an incident management system is Opsgenie™, available from Atlassian, Inc or Atlassian Pty Ltd.

A change request is a task relating to the service or product that is not an incident. In some embodiments all issues that are not incidents are deemed change requests. In other embodiments, change requests are a subset of issues that are not incidents. The creation of the issue for a change request may also be a manual process, for example, entered by a member of the development team, or an automated or semi-automated process, for example due to an interface with a system (e.g., a resource management system) for development team planning that generates information suitable for task creation.

The creation of issues, whether manual, automatic or semi-automatic, is performed by the issue generator 308. The issue generator 308 is configured to create issues associated with one or more objects. For example, a field of the data structure defining an issue may be used to specify one or more objects. In some embodiments, the objects available to be associated with an issue are those in the object registry 302. This may create a level of standardisation and uniformity, as well as facilitate efficient user interaction and interfaces. The available objects may be communicated from the data storage 301 to the issue generator 308, as indicated by arrow A in FIG. 3. The received available objects may be used to create an issue generator user interface. The issue generator user interface may, for example, include a drop-down menu or checkable list or other selectable affordances that list the available objects and enable one or more of the available objects to be selected. The received available objects may also or instead be used as a check against received data defining an object (e.g., when the issues are created based on the output from another system, with the check generating an error if the received data does not identify an available object). Data defining the created and/or generated tasks is stored in the issue store 304, as indicated by arrow B.

In some embodiments, an issue is creatable without being associated with an object. In these embodiments, the issue generator 308 may be configured to allow the issue to be edited to associate it with one or more objects. Similarly, the issue generator 308 may be configured with functionality that allows a previously created issue that is associated with one or more objects to be edited to add and/or remove associated objects.

The issue tracking system includes an issue view generator 310. The issue view generator 310 provides a user interface. The user interface enables the user to view one or more issues in one or more contexts. One example context is to view a representation of the content of the issue. Another example context is to view a representation of the issue in a schedule or list of issues. An example of a schedule of issues is an issue calendar that is configured to enable users to view (and optionally edit) when tasks associated with issues are scheduled to be performed. Scheduling information be stored as part of the issue, for example, in a field of the issue, or stored separate from the issue, but associated with the issue by data defining a cross reference or otherwise.

The issue view generator 310 receives data defining indicia to be displayed in relation to one or more issues from the issue store 304, as indicated by arrow C. The issue view generator 310 also receives data defining indicia to be displayed in relation to the one or more issues from a fetch issues function 312 in FIG. 3. When the issue view generator 310 is generating an issue that is of the category change request described above, the fetch issues function 312 operates to identify issues in the issue store 304 that are of the category incidents and which are associated with a common object as the change request. The issue view generator displays, together with the or as part of the displayed change request, indicia that represents the identified incident or incidents. Example user interfaces are described herein. In some embodiments, the displayed indicia include one or more selectable affordances and in response to selection of a displayed selectable affordance the issue tracking system displays details of the incident associated with the selectable affordance.

The fetch issues function 312 receives data to enable it to determine the incidents associated with the common object from the issue store 304, as indicated by arrow D, and provides data representing the determined incidents to the issue view generator 310, as indicated by arrow E. The fetch issues function 312 is described as a separate function to the issue view generator 310 in FIG. 3 for clarity of illustration. It will be appreciated that in some embodiments the fetch issues function 312 may be an integrated functional part of the issue view generator.

In some embodiments, the issue tracking system is unidirectional, in that incidents are fetched and displayed when change requests are caused to be displayed by the issue view generator, but change requests are not fetched and displayed when incidents are caused to be displayed. These embodiments may be suited, for example, to use cases in which the categories of issue types are incidents and change requests as described above. In other embodiments, the issue tracking system is bidirectional in that the second category of issues are fetched and displayed when the first category of issues is to be displayed, and the first category of issues are fetched and displayed when the second category of issues are displayed. In embodiments with selectable affordances, users may navigate between issues of the first and second categories that are associated with each other due to being associated with a common object.

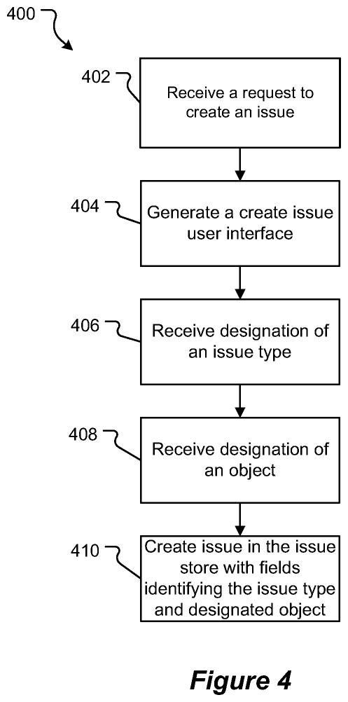

FIG. 4 shows a flow diagram of an example process 400 that may be performed by a processing system for generating an issue. The process may be implemented by the issue generator 308 executed by the processing system 200 as part of the networked environment 100 and the following description is given with reference to that example. The process 400 may be implemented by processing systems of other issue tracking systems.

At step 402, the processing system 200 receives a request to create an issue for the issue store 304. The request may be generated responsive to user interaction with the issue tracking system. For example, the issue tracking system may present a graphical user interface with a selectable option (e.g., an icon, menu item or other selectable user interface element) to create an issue, wherein the request to create an issue is the action of selecting the selectable option. Responsive to the request, at step 404, the processing system 200 generates a create issue user interface. The create issue user interface includes a data entry functionality to enable the user to enter details of the issue.

At step 406, the processing system 200 receives, through the create issue user interface, a designation of an issue type as between at least two different issue types. Two example issue types are the change request issue type and the incident issue type described above. There may be more than two different issue types, some of which may be neither of change request nor an incident. Also as described above, there may be a plurality of issue types that are deemed to be a change request or an incident issue type and in these embodiments there may or may not be an issue type called “change request” or “incident.”

At step 408, the processing system 200 receives, through the create issue user interface, a designation of an object. There may be one or more objects available to be designated. The one or more objects available to be designated may be predefined within the issue tracking system. For example, the create issue user interface may present a menu of available objects wherein the received designation of an object is a received selection action by the user from the presented menu. The objects available to be selected may be specified by the object registry 302.

At step 410, the processing system 200 creates the issue. The created issue is stored associated with the designated issue type and the designated object. For example, as shown in FIG. 4, the issue may be created as a data structure with fields that are populated with content directly identifying the designated issue type and the designated object or populated with content indirectly identifying the designations, for example, by pointing to another data structure that contains the identifying content. The created issue is stored in the issue store 304. The process 400 may be repeated to generate a plurality of issues and store them in the issue store 304.

In some embodiments, the issue tracking system is configured so that designating an issue type is mandatory in order to create an issue, whereas designating an object is optional. In other embodiments, both are mandatory, or both are optional. It will be appreciated that the issue generator 308 will implement a modified process, if an optional designation is not received, for example, by not including the relevant receive step(s) and not creating the issue with the relevant designation.

In some embodiments, the issue tracking system is configured so that an issue is constrained to having a single designated issue type, but may have zero, one or a plurality of designated objects.

The other details required to create an issue, or which can be optionally provided are determined by the configuration of the issue tracking system. In the context of a project management application, the project that the issue is to relate to, and a summary of the issue may be required. Other information that may be provided and included in or associated with the issue may include the product or service that the issue relates to, one or more document attachments, a detailed description relating to the issue, an identifier of the person requesting the issue, identification of any related or linked issues and/or details of who to assign the issue to, who is an approver in relation to the issue, which business or organisation the issue relates to, information relevant to prioritisation such as the impact and urgency associated with the issue and any other comments or information relating to the issue.

A similar process may be utilised to edit an issue that is existing in the issue store 304. Instead of a create issue user interface, an edit issue user interface is presented. The edit issue user interface is configured to receive or change a designation of the issue type and a designation of an object.

The issue tracking system may be configured to create and/or edit issues by one or more other mechanisms. For example, the content of the issue store 304 defining issues may be determined based on data received by the processing system 200 through a communication interface 216. That data may be received from another software service (e.g., another issue tracking system) through an application programming interface (API).

The issue tracking system may be configured to present an object creation user interface through with users can create objects in the object registry 302, so that they are available for selection in the create issue user interface. Alternatively, the issue tracking system may be configured to set the content of the object registry based on data received by the processing system 200 through a communications interface 216. For example, the content of the object registry may be determined based on data received from another software service (e.g., software maintaining a register of assets and/or services) through an application programming interface (API).

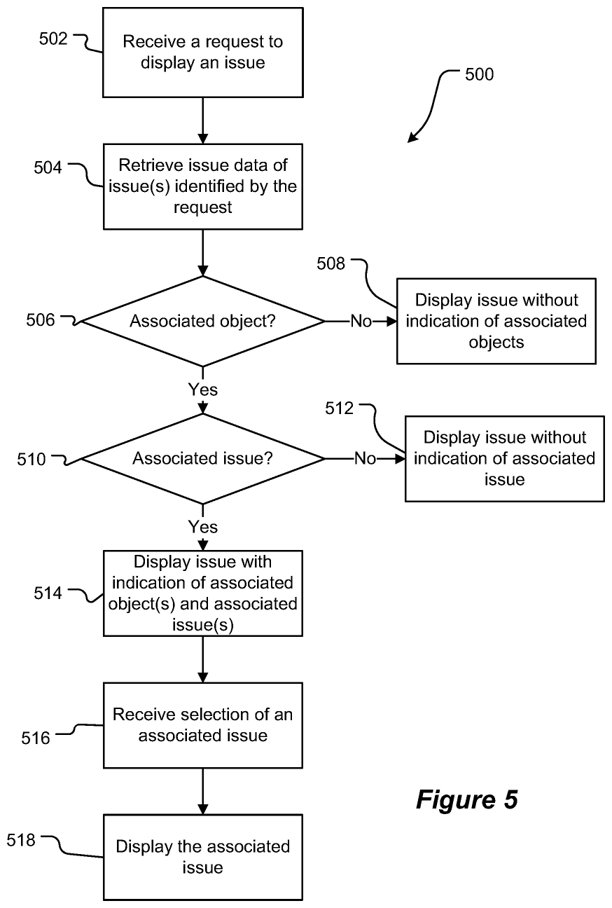

FIG. 5 shows a flow diagram of an example process 500 that may be performed by a processing system for generating a view of an issue. The process 500 may be implemented by the issue view generator 310 of the project management system 300 executed by the processing system 200. As described above, the processing system 200 (or another processing system) may be part of the networked environment 100 (or another networked environment). The process 500 may generate a view of an issue stored in the issue store 304, which as described above may have been generated and/or edited by the issue generator 308. The process 500 may be implemented by processing systems of other project management systems.

For clarity of illustration, the process 500 is described with reference to an embodiment of the project management system 300 in the networked environment 100, in which the functions 311 are performed by the server application 114 and the data storage 301 is within the data storage 118. For example, the client application 132 may be a browser interface, which communicates with the server environment 110 to send requests and to receive pages for display, the pages including one or more pages that display a view of one or more issues. It will be appreciated that other embodiments will have different distributions of logical and physical locations for the relevant functions and data storage.

At step 502, a request to display an issue is received by the server application 114 from the client system 130. The request was generated based on user action at the client system 130, for example, by the user operating the cursor control device 224 or the keyboard 226. The request is received while the user is interacting with a user interface of the client application 132. For example, the user may be navigating between user interface screen displays relating to a project containing a plurality of issues and the request is generated responsive to user input selecting a user interface element the represents a request to display an issue. The client system 130 communicates data representing the generated request to the server environment 110 for reception by the server application 114. The request to display an issue includes an identifier of the issue to display. The request may alternatively identify a plurality of issues in which case a corresponding plurality of issues may be displayed.

At step 504, the server application 114 determines the issue (or issues) identified by the received request and retrieves the data in the data storage 118 corresponding to each determined issue. In some embodiments the retrieval of data is via the data storage application 116. The retrieved data is represented by arrow C in FIG. 3. The retrieved data C may include a summary of the issue and other details relating to the issue which were included when the issue was created (or subsequently edited), for example according to the process 400. When the issue is associated with one or more objects (e.g., the objects in the object registry 302), then the retrieved data C includes identifier(s) of the object(s).

At step 506, the server application 114 either determines that the retrieved data does not include an identifier of an object, in which case the process proceeds to step 508, or determines that the retrieved data does include at least one identifier of an object, in which case the process proceeds to step 510. The content displayed for the requested issue is based on which determination is made.

At step 508, the server application 114 initiates a process to cause the client application 132 to display the requested issue(s) without an indication of associated objects. For example, the issue may be displayed in a window or panel on a graphical user interface and include various display regions in the window or panel in which indicia representing respective parts of the retrieved data C.

At step 510, the server application 114 either determines that each associated object determined in step 508 is not associated with another issue, in which case the process proceeds to step 512, or determines that at least one associated object is associated with another issue, in which case the process proceeds to step 514. The determination may be limited to an association with one or more particular categories or types of issue, for example, only “Incidents.” The content displayed for the requested issue is based on which determination is made.

In some embodiments, the determination that the associated object(s) is/are not associated with another issue is made when the issue is of a particular type. For example, if the issue relates to an “incident,” as described herein above, at step 510, then the issue is determined to not have any associated issues for the purpose of process 500. In these embodiments, the issue may be associated with other issues for other purposes, for example a group of incidents associated with a single project, a single object or otherwise and that association may be indicated in retrieved data C, but the issue is determined not to be associated issues for the purpose of process 500. In these embodiments, other issue types, for example “change request” issue types as described herein above may or may not have associated issues for the purpose of process 500. For these issue types, step 510 makes the determination based on the retrieved data C.

In other embodiments, the determination that the associated object is not associated with another issue is made based on the retrieved data C for all issue types. Optionally, there may be constraints as to which issue types can be associated with other issues for the purposes of process 500. This does not preclude association of those issue types with other issues by other mechanisms, for example, by using other fields in the issue that are not considered to make the determinations of step 510.

The process of step 510 may be performed using the fetch issues function 312. The fetch issues function 312 searches the issue store 304 for other issues that are also associated with the associated object(s) determined in step 506. In some embodiments, the search is across all issues in the issue store. In other embodiments, the search is constrained. An example constraint is to search only issues of a particular type. Using the example of a request in step 502 to display a “change request,” then the search may be constrained to “incidents” or may be constrained to exclude one or more types of issue (e.g., other change requests) but include one or more other types of issue (e.g., incidents). Another example constraint is to search only in issues related to the issue requested in step 502, for example, being related to the same product or service and/or being related to the same business or organisation.

In some embodiments, an identifier of each of the associated issues determined from step 510 is stored in data storage associated with data identifying the requested issue. The identifiers of associated issues may be stored in a different data storage to the data storage used to store the issues and may be non-transient memory or transient memory. The identifiers of determined associated issues may be available to the server application 114 and/or client application 132 for use in responding to subsequent user requests (see below). Alternatively, the fetch issues function 312 may be invoked again responsive to the subsequent user requests.

At step 512, the server application 114 initiates a process to cause the client application 132 to display the requested issue(s) without an indication of associated issue(s). As described in relation to step 508, the issue may be displayed in a window or panel with indicia representing respective parts of the retrieved data C. Step 512 includes displaying indicia representing the associated object(s) determined in step 506.

At step 514, the server application 114 initiates a process to cause the client application 132 to display on a display of the client system 130 the requested issue(s) with an indication of associated issue(s). The indication of associated issues(s) may be indicia that is one or more graphical user interface elements.

In some embodiments, step 514 includes causing the client application 132 to display both indicia representing the associated object(s) determined in step 506 and indicia representing the associated issue(s). In these embodiments, the indicia representing the associated issue(s) may be displayed in a way that identifies the associated object to which it relates. In this way a user can readily identify which objects have associated issues and which do not. This information may assist a user whether to consider the associated issues further or not, including whether to further interact with the issue tracking system to extract details of the associated issues.

While in some embodiments the indicia representing the associated issue(s) serves a notification purpose, in other embodiments, step 514 includes displaying selectable indicia. For example, the indicia representing the associated issue(s) may itself be selectable. In other embodiments, this indicium is displayed together with selectable indicia. The process 500 shown in FIG. 5 is a process in relation to embodiments with selectable indicia and includes step 516 and step 518.

At step 516, a selection of an associated issue is received by the server application 114 from the client system 130. The request was generated based on user action at the client system 130, for example, by the user operating the cursor control device 224 or the keyboard 226. The request is received while the user is interacting with a user interface of the client application 132.

At step 518, the server application 114 initiates a process to cause the client application 132 to display on a display of the client system 130 the associated issue(s). For example, the associated issue or issues may be displayed as list in a panel or in a new window of a graphical user interface of the client application 132. Subsequent selection of an associated issue in the list will cause the details of the issue to be displayed, which may be displayed in the same manner as issues are displayed in steps 508, 512 and/or 514. As described herein, in an example use case, an issue displayed in step 514 may be a “change request” and an issue displayed in step 518 may be an “incident” related to the “change request” due to both being associated with a common object.

It will be appreciated that in other embodiments the client application 132 may be able to perform actions in process 500 without needing to request actions or data from the server application 114. For example, if the client system 130 maintains a cache and the data needed for steps 504, 506, 510 or 518 is in the cache, then there may be no need for requests to be made or passed on to the server environment 110.

The following description provides example screen displays for some of the processes described herein above. The screen displays may be displayed on a physical display screen of the client system 130. The screen displays may represent some or all of the information displayed on the screen at that time. The screen displays may fit on a physical display screen or may extend beyond the physical display screen, in which case a scroll or other navigation function may be used to view a portion of the screen display not currently on the physical display screen.

FIG. 6 shows an example screen display 600 for creating an issue. The screen display 600 may be displayed in response to a user selecting a create issue button or other user interface element in the issue tracking system.

The screen display 600 includes several input regions for a user to enter or select information. The selection function may be by a drop-down menu, which may be accessed by selecting the chevron on the input regions or through another user interface arrangement, for example a new window that appears when the input region is selected. Some or all of the input regions may enable entry of text (e.g., input region 610). In some embodiments the issue tracking system constrains the user to selecting from a plurality of preconfigured options for several of the input regions. These may include or consist of input regions 602, 604, 608 and 616 and may also include the input regions shown with chevrons in FIG. 6 and the following description assumes the system has been configured with this constraint. The preconfigured options are configured using other functionality of the issue tracking system. Data or instructions defining the preconfigured options may be in the data storage 118 or the non-transient memory 210.

The input region 602 allows a user to enter a project to allocate the issue to and the input region 604 allows a user to assign the issue a (first) issue type. An example may be the previously described “bug issue type.” A project may include allocated issues with assigned issue types and have one or more workflows that include the issues assigned to it, which workflow may be dependent on the issue type. The workflows enable tracking of the progress of a plurality of issues.

The input region 608 allows a user to assign the issue a (second) issue type, called a request type in this example. The selectable options are the categories of issue described herein, including at least the first category of issue (e.g., “incident”) and the second category of issue (e.g., “change request”).

The input region 610 allows a user to enter more details regarding the issue. These details may include a text summary, a text detailed description and/or files with information. The input region 610 may be implemented as a plurality of input regions.

The input region 612 represents one or more input regions for designating one or more names for the issue. The designated names may include, for example, the name or other indicator of a person to whom the issue is assigned and the person creating the issue.

The input region 614 allows a user to enter one or more issues that are associated with the issue. The input region 614 allows the user to specify associated issues according to criteria other than the association via an object as described herein (e.g., as determined by steps 506 and 510 of the process 500). Those other criteria may be independent to the association via an object and may for example relate to a workflow in a project. Accordingly, the issues selected using input region 614 may or may not be issues that are also associated with the issue requested to be created via an object.

The input region 616 allows a user to enter one or more objects that are associated with the issue. The objects available for selection may be specified by the object registry 302. The objects that are input by the user are used for the determinations in steps 506 and 510 of the process 500.

The input region 616 allows a user to enter priority information for the issue. For example, the labels “Urgent,” “Important,” “Critical,” “Medium” or “Low” may be assigned to the issue.

The screen display 600 includes a create button 620. Selection of the create button by the user causes the issue tracking system to create the issue according to the information input using the screen display 600. In the embodiment shown the screen display 600 also includes selectable indicia “Import issues,” which when selected by a user causes the issue tracking system to initiate a process to import existing data defining issues from another source.

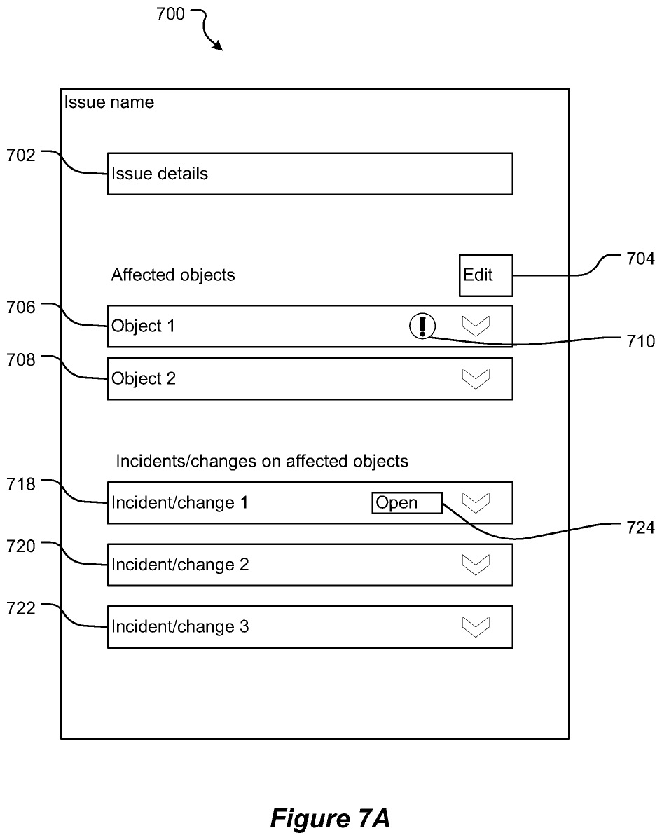

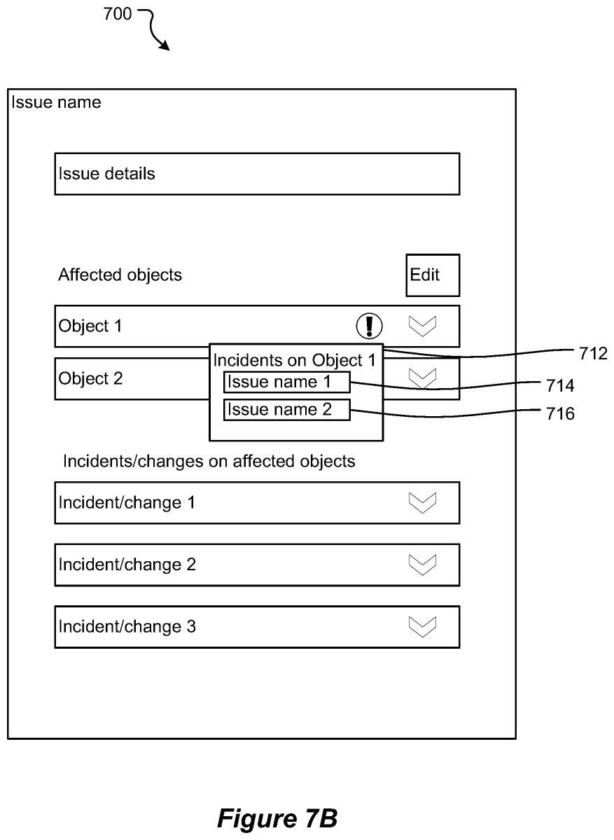

FIG. 7 shows an example screen display 700 showing details of an issue. The screen display 700 may be displayed in response to a user navigating within the issue tracking system and selecting the issue for display. For example, the user may have navigated to the project for the issue (e.g., as assigned using the input region 616), which caused the issue tracking system to display the issues associated with the project and the user may have selected an issue for display.

An identifier of the issue is displayed, which in this example is a generic “Issue name.” The issue name may correspond to information entered or received on issue creation, for example, a summary entered using the screen display 600.

The screen display 700 may include details corresponding to the information entered in one or more of the input regions 602, 604, 608, 610, 612, 614 and 618. These may be displayed in one or more regions of the screen display 700, and these one or more regions are represented in FIG. 7 by the “Issue details” region 702.

The screen display 700 includes indicia representing the objects that the issue is associated with. These objects may correspond to those entered using the input region 616 or otherwise received by the issue tracking system on issue creation. The objects may correspond to those entered in any edit of the issue subsequent to its creation. In some embodiments the screen display 700 includes selectable indicia, in this example an “Edit” button” 704, to initiate a process to edit the associated objects. In the example of FIG. 7 two associated objects are displayed, under a heading or label “Affected objects,” an associated object 706 labelled “Object 1” and an associated object 708 labelled “Object 2.” It will be appreciated that more descriptive labels will be used in practice and that these labels may be predefined, by or based on data in the object registry 302.

The associated object 706 is displayed with a notification 710. The notification 710 is included when the issue tracking system determines that there is an issue associated with that object, for example, as described with reference to step 510 of the process 500. The notification 710 may therefore provide feedback to a user on issues related to the current by the affected objects. For example, if the issue is a “change request,” then the notification 710 may indicate that there is one or more “incidents” on “Object 1,” which may for example be a service offered by software, such as a billing service.

In some embodiments, each associated object is displayed with one or more selectable indicia that a user can select to display additional information on the associated object. The additional information may include, for example, a more detailed description of the service. When there is an issue associated with the object the additional information may include details of the associated issue. Example selectable indicia are the chevrons of FIG. 7. In addition, or alternatively selecting the name (e.g., Object 1) or on the panel representing the object causes additional information to be displayed. In addition, or alternatively, the selectable indicia are the notification 710. In some embodiments, one of the selectable indicia (e.g., the notification 710) shows only information on issues associated with the object and does not show other information such as a description of the service.

FIG. 7B shows an example of the display of additional information on issues associated with the object. In this example, a new panel 712 is displayed over the issue and the panel includes indicia 714, 716 representing each associated issue, which in the example of FIG. 7B is represented by the generic labels “Issue name 1” and “Issue name 2.” The indicia 714, 716 may include or consist of selectable indicia and selection of the indicia 714, 716 may cause the issue tracking system to display the issue. The display of the issue may be in the same or a similar form as shown in FIG. 7A. In other words, there is a consistent display format for issues. The display of the associated issue may replace display of the existing issue or may be displayed together with the existing issue, for example as tiled panels in a collective display screen.

Returning to FIG. 7A, in some embodiments, the screen display 700 includes a region for displaying issues that are associated with the affected objects. The example includes three issues 718, 720 and 722. In some embodiments, the associated issues that are displayed within an issue are of a different category to that issue. For example, when the screen display 700 is displaying the category of issue “change request,” then the associated issues are “incidents.” In other words, any other change requests that are also associated with the affected objects are not displayed. Similarly, when the screen display 700 is displaying the category of issue “incident,” then the associated issues are “change requests.” In other embodiments, issues of the same category that are associated with common objects are displayed, either in the same region or in a different region. In some embodiments, the associated issues are displayed with a status indictor 724. For example, incidents may have a status of open, completed, cancelled and/or other statuses. As before, the chevrons for the issues 718, 720 and 722 represent selectable indicia that when selected causes the display of additional information on the issue. The additional information may include actionable items and further selectable indicia may be displayed to initiate a process to complete an action.

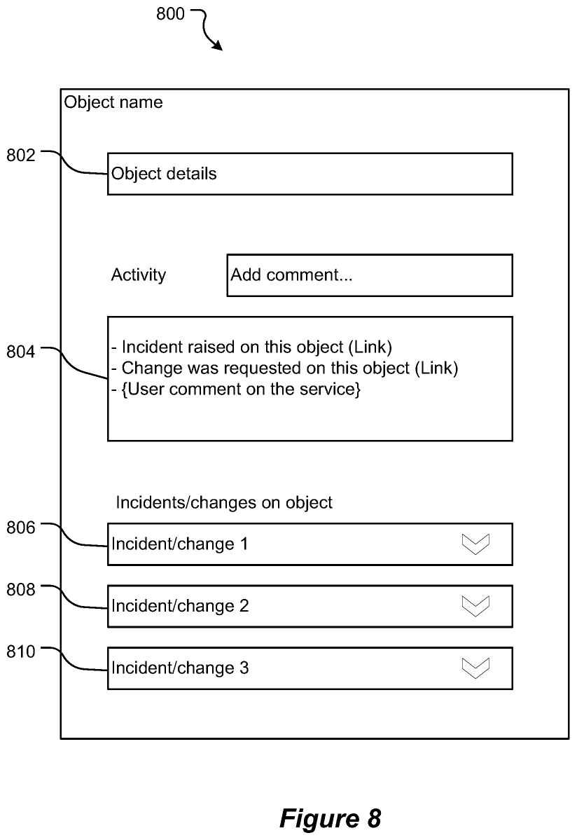

FIG. 8 shows an example of a screen display 800 with additional information on an object. The screen display 800 may be accessed directly or indirectly from the screen display 700, for example, by selecting a panel in the screen display 700 that is displaying the object or may be accessed by otherwise navigating within the issue tracking system. The screen display 800 includes indicia identifying the object, in this example, a generic “Object name.” The screen display 800 includes in one or more regions details of the object. These are represented by region 802 called “Object details” and may include items such as a description of the object.

The screen display 800 may include an activity feed 804 for the object. The issue tracking system may be configured to automatically populate the activity feed with notifications when an issue or a particular category of issue (e.g., an “incident” or “change request”) is associated with the object. The activity feed may be presented in chronological order, for example with the most recent notifications appearing at the top of the feed, or otherwise presented to show a timeline. Users may navigate the activity feed (e.g., by scrolling if the feed extends beyond a screen display) to see a history in relation to the object. The activity feed may include selectable indicia to navigate to more information on the associated issue or to navigate to a display screen (e.g., like FIG. 7A) showing the issue, represented in FIG. 8 by “(Link)”. Users of the issue tracking system may be able to add comments on the object and these may appear in the activity feed, visible to other users. Other information may also be included in the activity feed, such as service status and deployment information for the object.

The screen display 800 may also include a region for displaying issues that are associated with the objects. Three example issues 806, 808 and 810 are shown in FIG. 8. If the object being displayed in screen display 800 was “Object 1” from FIG. 7A, then these example issues 806, 808 and 810 may correspond with issues 718, 720 and 722, respectively. Like in FIG. 7A, the issues may be displayed with a status (not shown in FIG. 8).

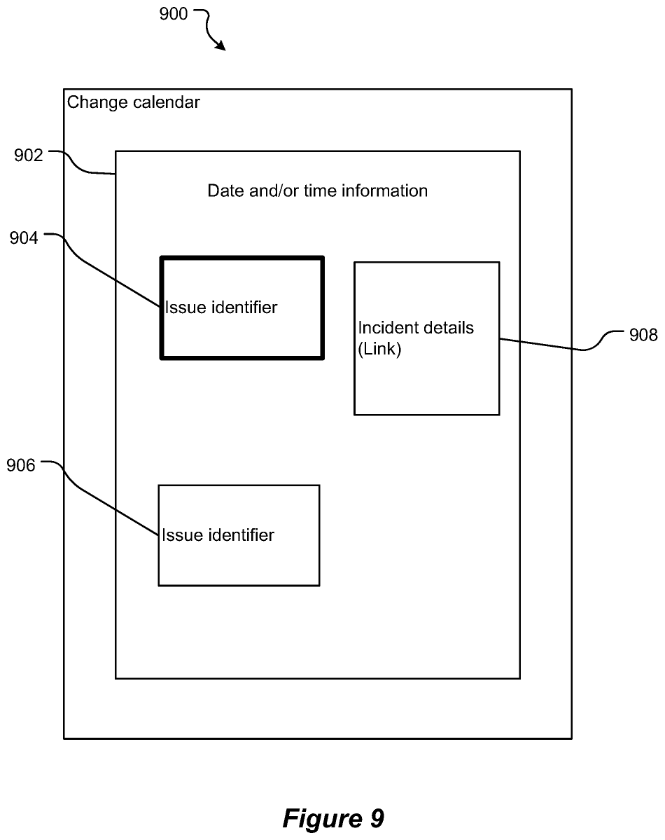

FIG. 9 shows an example of a screen display 800 showing a change calendar. The change calendar may be populated with issues of the issue tracking system, each identified by an issue identifier and appearing at a location in the calendar, for example, on a date and/or time. Two issues 904, 906 are shown. The issue tracking system is configured to cause indicia to be displayed in the change calendar that indicates when a displayed issue has an associated issue, for example, an association, as described with reference to steps 506 and 510 of the process 500. In the example, the issue 904 has at least one such associated issue, and this is indicated by the border of the issue being highlighted or emphasised. Details of the associated issue(s) may be displayed in the change calendar, for example in panel 908, which may include selectable indicia to navigate to any of the associated issue(s), represented in FIG. 9 by “(Link).” In some embodiments, panel 908 is not initially displayed and is displayed responsive to a user selecting the issue 904.

The flowcharts illustrated in the figures and described above define operations in particular orders to explain various features. In some cases, the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Still further, the functionality/processing of a given flowchart operation could potentially be performed by different systems or applications.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

What is claimed is:

1. A computer implemented method, including:
providing, by one or more computer processing systems, an issue tracking system, wherein the issue tracking system includes a plurality of issues, including a first issue of a first category or type and a second issue of a second category or type, different to the first category or type, wherein the first issue is designated by the issue tracking system as associated with a first object of the issue tracking system and the second issue is designated by the issue tracking system as associated with the first object of the issue tracking system; and
by the one or more computer processing systems:
receiving a request to display the first issue;
determining that a) the first issue is of the first category or type and not the second category or type and b) the first issue is associated with the first object and c) the first object is associated with the second issue; and
responsive to the request to display the first issue and the determining, causing a display device to display a screen display representing the first issue to include indicia that represents an association of the first issue with another issue, wherein the indicia include one or more user interface elements.

2. The method of claim 1, wherein at least one of the user interface elements is selectable, the method further including receiving, by the one or more computer processing systems, user selection of a said selectable user interface element and in response causing the display device to display information on the second issue.

3. The method of claim 2, wherein the information on the second issue is displayed over the issue screen display, wherein information on the first issue remains visible to the user.

4. The method of claim 2, wherein the information on the second issue includes an identifier of the second issue.

5. The method of claim 4, wherein the information on the second issue includes or is displayed with selectable indicia, and wherein the method further includes receiving, by the one or more computer processing systems, user selection of the selectable indicia and in response displaying additional information on the second issue.

6. The method of claim 1, wherein the first object is a software service or a hardware product.

7. The method of claim 1, wherein the first issue is of a third type, wherein the third type is not a member of the first category or the second category and is different to the first type and the second type, and wherein the third type is associated with a workflow in the issue tracking system.

8. A computer implemented method, including:
receiving, at a computer processing system:
a request to create a first issue for an issue tracking system;
a designation of an issue category or type for the first issue; and
a designation of at least one object for the first issue, wherein the at least one object is a first service or a first product;
a request to create a second issue for the issue tracking system;
a designation of an issue category or type for the second issue, different to the corresponding designation for the first issue; and
a designation of at least one object for the second issue, wherein the at least one object includes the first service or the first product;
creating the first issue and the second issue for the issue tracking system, including storing in data storage data defining the first issue and the second issue, including data representing the received designations; and
while displaying details of the first issue in a user interface of the issue tracking system, displaying indicia that indicates that the second issue includes a designation of the first service or the first product.

9. The method of claim 8, including displaying as part of or with the displayed indicia, a selectable user interface element and including, responsive to selection of the selectable user interface element, displaying information on the second issue, wherein the information is based on data from the data storage.

10. The method of claim 8 wherein:
the designation for the first issue designates the first issue as a request for a change to a product or service, wherein the product is or includes the first produce or the service is or includes the first service; and
the designation of the second issue designates the second issue as an incident relating to the product or service.

11. The method of claim 10, wherein the user interface of the issue tracking system is a user interface of a change calendar.

12. A computer processing system comprising:
a processing unit;
a communication interface; and
a non-transitory computer-readable storage medium storing instructions, which when executed by the processing unit, cause the processing unit to provide an issue tracking system, wherein providing the issue tracking system includes:
providing, in data storage, an object registry for defining objects to which issues relate, wherein the objects relate to a product or service;
providing, in the data storage, an issue store for a plurality of issues;
causing, through the communications interface, a user interface to be displayed on a display device, the user interface including a plurality of screen displays navigable by a user of the issue tracking system, the plurality of screen displays including:
at least one screen display for creating or editing an issue for or in the issue store, including a first screen display for selecting an object from the object registry for association with the issue; and
at least one screen display for presenting details of an issue, including a second screen display that displays details of a first issue associated with an object from the object registry and includes indicia that indicates there is at least a second issue in the issue store associated with the same object in the object registry.

13. The computer processing system of claim 12, wherein the at least one screen display for presenting details of an issue includes a third screen display for presenting details of the second issue and wherein the user interface is configured to provide a user with access to the third screen display via the second screen display.

14. The computer processing system of claim 13, wherein the indicia includes first indicia that indicates that there is at least a second issue in the issue store associated with the same object in the object registry and second indicia that identifies a plurality of issues in the issue store associated with the same object in the object registry, including the second issue, and wherein the second indicia is displayed responsive to a selection action by the user while the first indicia is displayed.

15. The computer processing system of claim 14, wherein the at least one screen display for presenting details of an issue includes a third screen display for presenting details of the second issue, and wherein the user interface is configured cause display of the third screen display responsive to a selection action by the user while the second indicia is displayed.

16. The computer processing system of claim 12, wherein the second screen display includes second indicia identifying the same object, and wherein the second indicia is presented in the second screen display associated with the indicia that indicates there is at least a second issue in the issue store associated with the same object in the object registry.

17. The computer processing system of claim 12, wherein the second screen display includes third indicia identifying another object, and wherein the second indicia is presented without being associated with the indicia that indicates there is at least a second issue in the issue store associated with the same object in the object registry.

18. The computer processing system of claim 12, wherein the at least one screen display for creating or editing an issue for or in the issue store includes a screen display for categorising the issues into one or a plurality of categories, and wherein the indicia that indicates there is at least a second issue in the issue store associated with the same object in the object registry is displayed dependent on the categorisation of at least one of the first issue and said at least second issue.

19. The computer processing system of claim 13, wherein the second screen display is in a calendar format.

20. The computer processing system of claim 12, wherein the plurality of screen displays includes a third screen display that displays details of the object from the object registry, the details including a notification that the first issue was associated with the object and a notification that the second issue was associated with the object.
